(19) United States
(12) Patent Application Publication
(10) Pub. No.: US 2017/0015231 A1
(43) Pub. Date: Jan. 19, 2017

(54) BULK CONTAINER TRANSPORT SYSTEM

(71) Applicants: Murray J. Moran, Biloxi, MS (US); Murray L. Moran, Biloxi, MS (US)

(72) Inventors: Murray J. Moran, Biloxi, MS (US); Murray L. Moran, Biloxi, MS (US)

(21) Appl. No.: 14/800,578

(22) Filed: Jul. 15, 2015

(51) Int. Cl. B60P 1/60; B60P 1/64

(52) U.S. Cl. CPC B60P 1/60; B60P 1/6418; B60P 1/6409

(57) ABSTRACT

A material storage and transfer system includes a material carrier assembly, discharge valves, a transport conduit, and an air blower. The material carrier assembly includes a framework and compartments. The framework includes locking apertures to attach to a trailer platform of the traction vehicle and to attach to another material carrier assembly. The compartments are positioned within the framework and stores a material for transport. The discharge valves, comprising pneumatic valves and gravity valves, attached to the bottom of each compartment, and the transport conduit in communication with the discharge valves receive the material, where one end of the transport conduit is connected to an air blower and an opposing end is defined as a discharge end. The air blower blows air through the transport conduit to extrude the material received within the transport conduit through the discharge end towards an external storage device or an external process.

### CROSS-REFERENCE TO RELATED APPLICATIONS

This application claims priority to U.S. Provisional Patent Application No. 61/958,302 titled “Bulk Container Transport System”, filed in the United States Patent and Trademark Office on Jul. 25, 2013 on behalf of Murray Joseph Moran, et. al. The specification of the above referenced patent application is incorporated herein by reference in its entirety.

### BACKGROUND

The conventional method of transporting small particle size matter is a process that involves the use of numerous transportation and transload devices that subject the material to a number of ways of contamination and/or spoilage. Conventionally, materials, especially particulate materials are transported by trailer trucks, for example, a tractor with an attached trailer having a storage tanks and accessory fittings to discharge the particulate material. Apart from trailer trucks other transportation means like railcar, barge, etc. are also used in the art. Often, these transport containers are denoted to as hydraulic containers since the container is hydraulically tilted to dislodge the sand from the container. Materials that are typically transported using such trucks include agro products such as wheat grains, corn kernels, beans, flour, sugar, salt, peanuts and the like, and intermediate products for various industrial uses such as lime, silica gel, powdered substances such as acid resins, rare earth substances and powder form of alumina.

There is a need for a device that can be loaded at the product origin under controlled conditions and moved from truck to rail or barge and other means of transportation without disturbing or impacting the actual product itself. There is a need for a device that allows for the product to be sealed at the port of origin, transported and handled by various transportation methods, and unloaded at the final destination without damage, contact or contamination of the individual product. In addition, the device should have the ability to be locked to control chain of custody of material and combined with other similar containers creating an immediate and inexpensive large capacity storage center.

Hence, there is a long felt but unresolved need for a material storage and transfer system configured to be transported on a traction vehicle, which can store and transport material under controlled conditions, and attached or locked to control chain of custody of material, therefore to combine with other similar containers to create a large capacity storage center. Further, there is a need for this a material storage and transfer system for safety and other reasons to enable the discharge of material load via gravity as well as pneumatic means.

### SUMMARY OF THE INVENTION

The material storage and transfer system disclosed herein addresses the above stated needs for storing and transporting material under controlled conditions, and attaching to a control chain of custody of material, therefore to combine with other similar containers to create a large capacity storage center. The material storage and transfer system configured to be transported on a traction vehicle comprises a material carrier assembly, one or more discharge valves, a transport conduit, and an air blower. The material carrier assembly comprises a framework and one or more compartments. The framework comprises locking apertures to removably attach to a trailer platform of the traction vehicle and to removably attach to another material carrier assembly.

The compartments are positioned within the framework and are configured to store a material for transport. The discharge valves are fixedly attached to a bottom section of each of the compartments, and the transport conduit in communication with the discharge valves is configured to receive the material, where one end of the transport conduit is connected to an air blower and an opposing end is defined as a discharge end. The air blower is configured to blow air through the transport conduit to extrude the material received within the transport conduit through the discharge end towards an external storage device or an external process. In an embodiment, the discharge valves comprise a set of pneumatic valves and a set of gravity valves configured to be selectively activated during material transport, that is, the discharge valves fixedly attached to the container are a combination of both gravity discharge and pneumatic discharge. These valves are easily reached from ground level for safety, and the gravity discharge further aids to health safety due to reduction in silica dust.

In an embodiment, the material storage and transfer system disclosed herein further comprises an air pressurization pipe fixedly attached to the upper surface of the compartments, where the air pressurization pipe is configured to supply pressurized air from the air blower to pressurize the materials in the compartments, therefore to increase the rate of extrusion via the discharge valves. In an embodiment, wherein the transport conduit is an air transport pipe. In an embodiment, wherein the transport conduit is a conveyor belt configured to receive the material through the discharge valves under gravity, where the conveyor belt transfers the material to a storage space located at a predefined height.

### BRIEF DESCRIPTION OF THE DRAWINGS

FIG. 1 exemplarily illustrates a side perspective view of the material storage and transfer system.

FIG. 2 exemplarily illustrates an embodiment of the material storage and transfer system comprising a conveyor belt.

FIG. 3A exemplarily illustrates a front view of the compartments.

FIG. 3B exemplarily illustrates a front view of the framework with the compartments.

FIG. 3C exemplarily illustrates a side perspective view of the compartment.

FIG. 3D exemplarily illustrates a side perspective view of the framework.

FIG. 4A exemplarily illustrates a side perspective view of the compartment and the discharge valve.

FIG. 4B exemplarily illustrates a front perspective view of the compartment, the transport conduit and the discharge valve.

FIG. 5 exemplarily illustrates a method of storing, transporting and transferring a material using the material storage and transfer system.

### DETAILED DESCRIPTION OF THE INVENTION

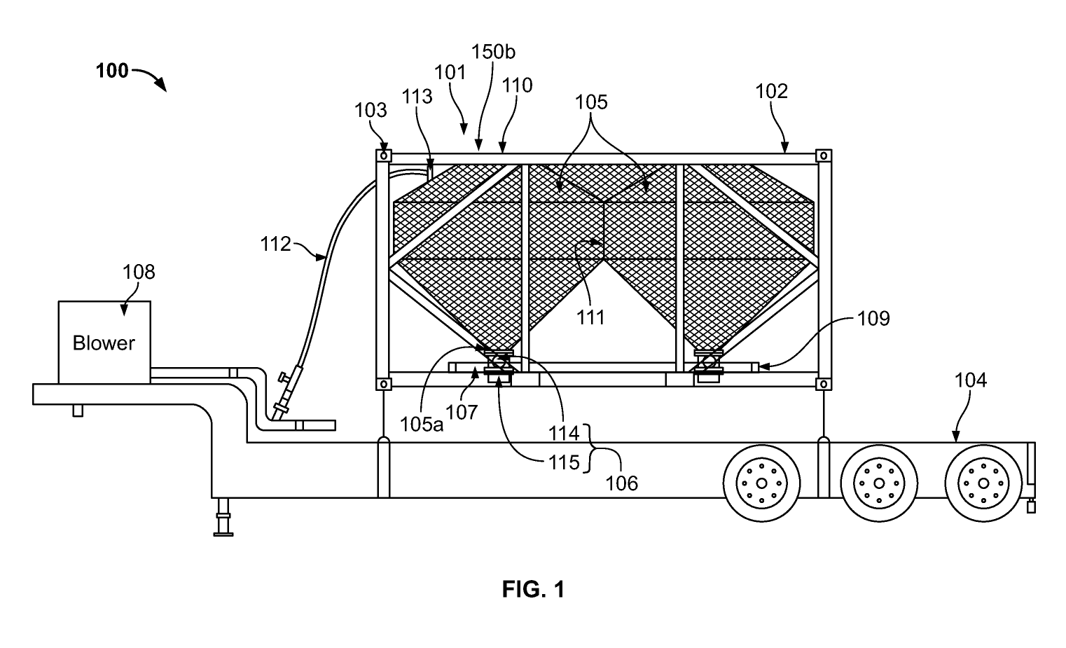

FIG. 1 exemplarily illustrates a side perspective view of the material storage and transfer system 100. The material storage and transfer system 100 configured to be transported on a traction vehicle comprises a material carrier assembly 101, one or more discharge valves 106, a transport conduit 107, and an air blower 108. The material carrier assembly 101 comprises a framework 102 and one or more compartments 105. The framework 102 comprises locking apertures 103 to removably attach to a trailer platform 104 of the traction vehicle and to removably attach to another material carrier assembly 101, therefore establishing a certainty in chain of custody for the material carrier assemblies 101 from loading at mine location to unloading at a well site.

The compartments 105 are positioned within the framework 102 and are configured to store the material for transport. The framework 102 is, for example, 8.5 inches high, about 20 inches long and about 8 inches wide. In an embodiment, the discharge valves 106, for example, a set of pneumatic valves 114 and gravity valves 115, are fixedly attached to a bottom section 105a of each of the compartments 105 and are configured to be selectively activated during material transfer, that is, the discharge valves 106 fixedly attached to the container are a combination of both gravity discharge and pneumatic discharge of the material. These valves 114 and 115 are easily reached from ground level for safety, and the gravity discharge further aids to health safety due to reduction in silica dust. In an embodiment, the transport conduit 107 in communication with the discharge valves 106, for example, the pneumatic valve 114, is configured to receive the material, where one end of the transport conduit 107 is connected to an air blower 108 and an opposing end is defined as a discharge end 109. The air blower 108 is configured to blow air through the transport conduit 107 to extrude the material received within the transport conduit 107 through the discharge end 109 towards an external storage device or an external process.

In an embodiment, the discharge valves 106, for example, the gravity valves 115 are configured to discharge the material into the transport conduit 107 at a predefined angle, for example, about 37 degrees. In an embodiment, wherein the transport conduit 107 is, for example, an air transport pipe. In an embodiment, the material storage and transfer system 100 disclosed herein further comprises one or more loading hatches 110 positioned on an upper surface 105b of the compartments 105, where the loading hatches 110 are configured to fill the compartments 105 with the material. In an embodiment, the compartments 105 are isolated from each other via internal dividers 111, wherein each isolated compartment 105 is configured to be loaded with a different material.

In an embodiment, the material storage and transfer system 100 disclosed herein further comprises an air pressurization pipe 112 fixedly attached to the upper surface 105b of the compartments 105, where the air pressurization pipe 112 is configured to supply pressurized air from the air blower 108 to pressurize the materials in the compartments 105, therefore to increase the rate of extrusion via the discharge valves 106. In this example, the framework 102 or the outer skeletal structure is supporting the compartments 105 or the internal storage bays that would be loaded from the top via loading hatches 110, for example, two high volume loading hatches 110 with bulk, loose, granular substances, powders or liquids for transportation and storage.

The material carrier assembly 101 can be moved around via forklift access cavities or standardized freight corner loading and locking apertures 103. Standardized freight corner loading and locking apertures 103 allow for familiar, standardized loading, unloading and connecting of the material carrier assembly 101 to traditional rail, truck and ocean transportation. In an embodiment, the compartment 105 is, for example, made of two halves that can either be used as one large compartment 105 for one product or separated by the internal divider 111 allowing two different materials to be loaded and isolated from each other. In an embodiment, the compartment 105 comprises two separate material discharge valves 106. In another embodiment, each material discharge valve 106 has the gravity valve 115 which is configured as an internal valve adjacently connected to the pneumatic valves 114, where the gravity valve 115 enables the user to allow the material to fall directly out of the material discharge valves 106 via gravity and to divert the material at an approximate angle of, for example, about 37 degrees, into the air transport pipe 107 where forced air from the air blower 108 which carries the material down the air transport pipe 107 into another storage container such as a third party external storage device. As used herein, the term “air transport pipe” shall generally refers to a conduit capable of transporting air and other material from one point to another. The air transport pipe 107 is made of, for example, plastic, metal, or any other suitable material.

The integrated air blower 108 mounted onto the trailer platform 104 along with a power supply provides the user a turnkey solution to unloading the material carrier assembly 101. The integrated air blower 108 is configured with multiple valves and pressure gauges to allow the user to regulate the air pressure applied to both the compartment 105 and the air transport pipe 107. The trailer platform 104 has compressed air so any traction vehicle can be used regardless of the compressed air capabilities. A user could choose to add pressure to the compartment 105 by blowing air from the air blower 108 via the air pressurization pipe 112 and through the storage bay pressurization inlet 113 to aid in the unloading of the material carrier assembly 101. As used herein, the term “storage bay pressurization inlet” shall generally refer to a valve or a gate that allows air to enter the storage bay but not escape the storage bay thus creating a prescribed amount of pressure within the storage bay. The storage bay pressurization inlet 113 is made from, for example, plastic, metal or any other suitable material. In an example, the material carrier assembly 101 is configured to be mounted via standardized freight corner loading and locking apertures 103 to a trailer platform 104.

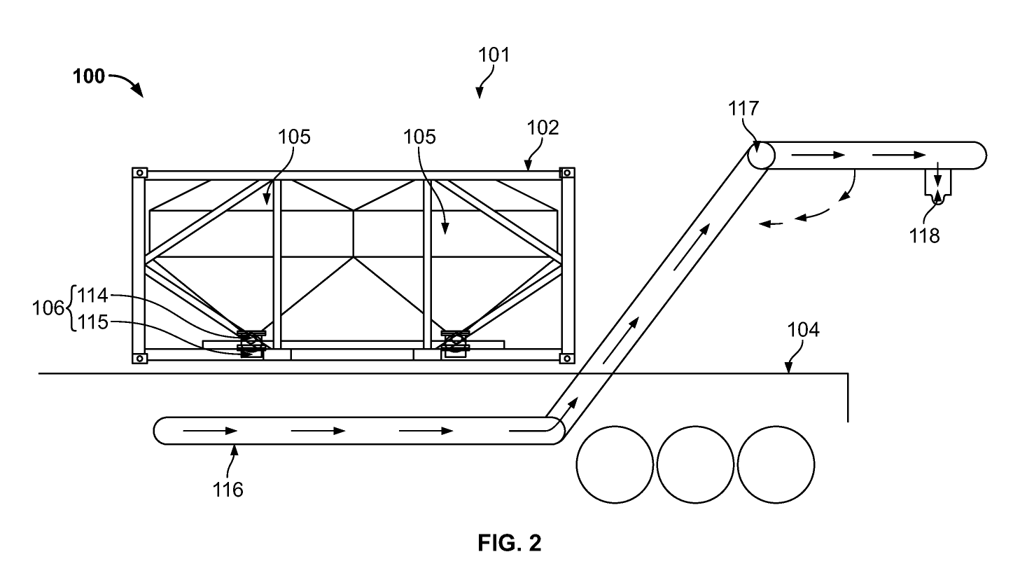

FIG. 2 exemplarily illustrates an embodiment of the material storage and transfer system 100 comprising a conveyor belt 116, for example, a “Z” type conveyor belt, for unloading the compartment 105. In an embodiment, wherein the transport conduit 107 is a conveyor belt 116 configured to receive the material through the discharge valves 106, for example, the gravity valves 115, under gravity, where the conveyor belt 116 transfers the material to a storage space located at a predefined height. The gravity valves 115 can unload the material, for example, sand via gravity within about 8 minutes. The gravity valves 115 will discharge the material at an acceptable rate onto a “Z” type conveyor belt 116 integrated into the trailer platform 104 that will miry the material up through the trailer platform 104 continuing to carry the material vertically until reaching the conveyors pivot arm 117 then the material will travel horizontal until it falls into the material discharge chute 118. This configuration may be used when industry standards call for gravity feeding the material into a third party storage container.

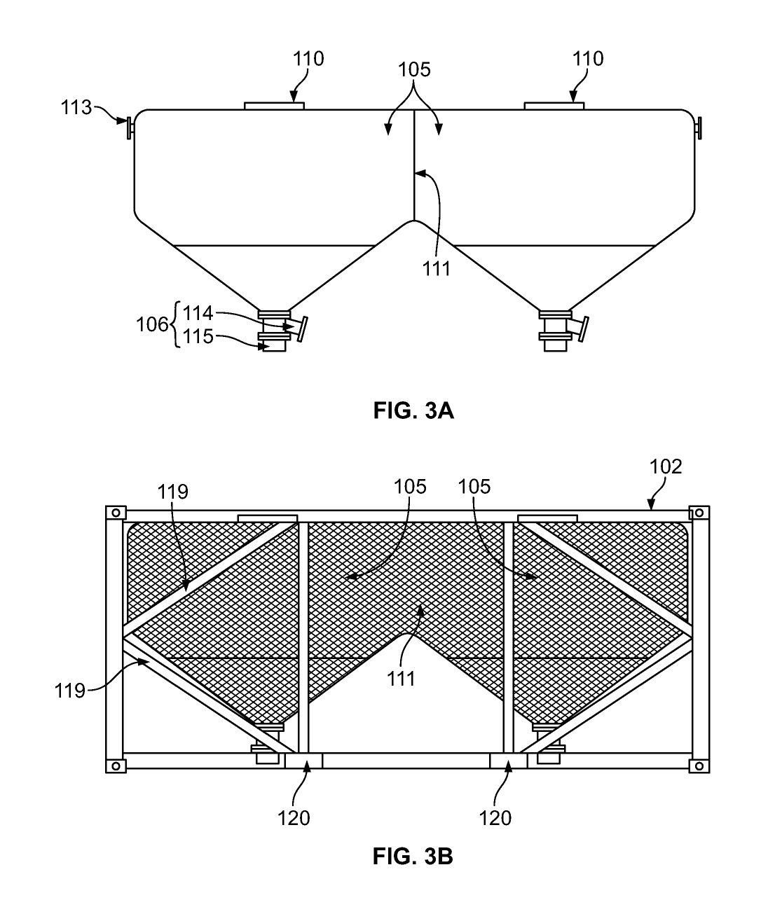

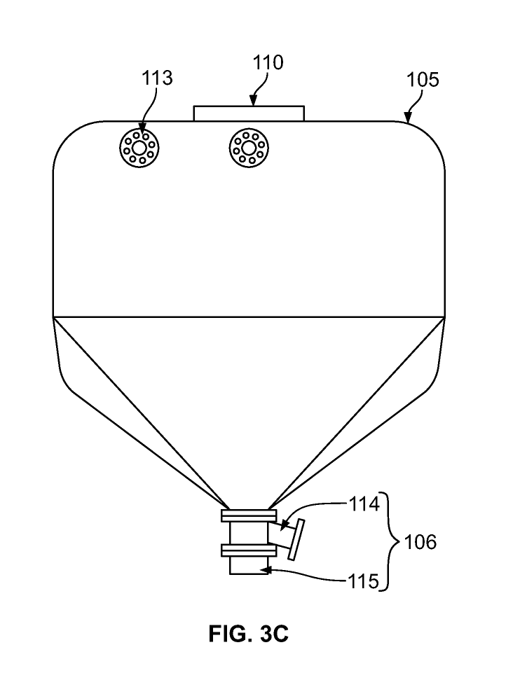

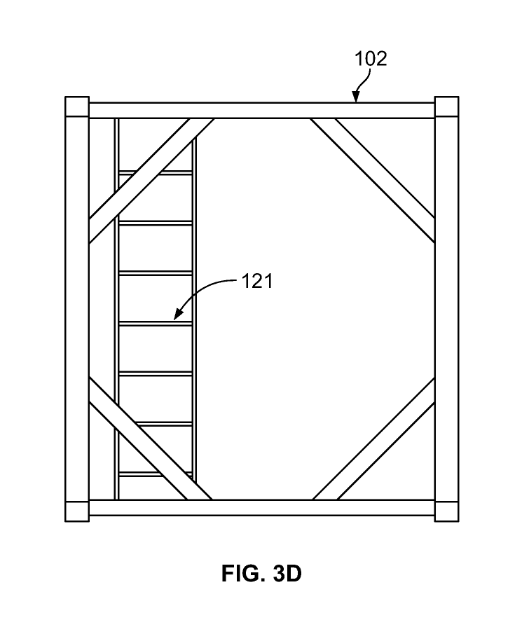

FIGS. 3A-3D exemplarily illustrate a front view of the compartments 105 in FIG. 3A, a front view of the framework 102 in FIG. 3B, a side perspective view of the compartment 105 in FIG. 3C, aside perspective view of the framework 102 in FIG. 3D. The compartment 105 has one, two, or more high volume loading hatches 110, storage bay pressurization inlet 113 and material discharge valves 106 and an optional internal divider 111. In an embodiment, The framework 102 comprises horizontal, vertical and angled support beams 119, fork lift access cavities 120, standardized freight corner loading and locking apertures 103, and a ladder 121 at the rear to allow a person to climb to the top of the framework 102 as shown in FIG. 3B and FIG. 3D.

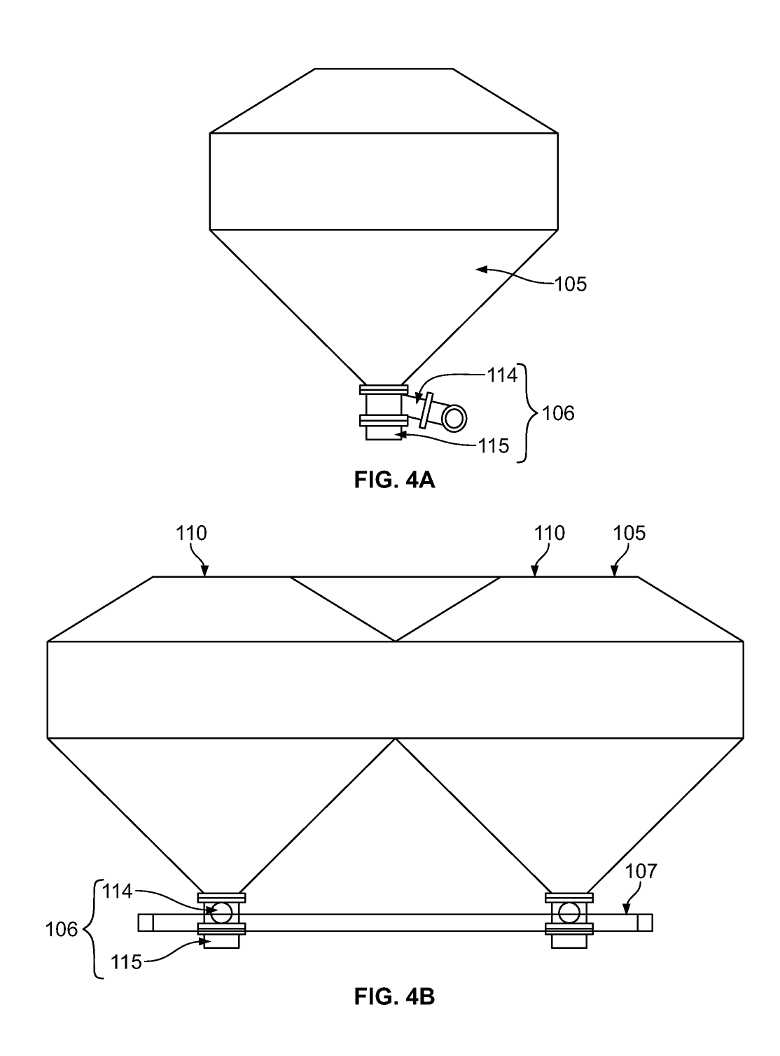

FIG. 4A exemplarily illustrates a side perspective view of the compartment 105 and the discharge valve 106, and FIG. 4B exemplarily illustrates a front perspective view of the compartment 105, the transport conduit 107 and the discharge valve 106. In an embodiment, the material carrier assembly 101 is loaded with small granular sized material in bulk and may be secured in the compartment 105 with a locking hatch 110 that allows for chain of custody accountability. The material storage and transfer system 100 allows for dry, secure transportation and storage of material. The compartments 105 of the material storage and transfer system 100 disclosed herein prevent the material from being exposed to moisture, eliminates risk of contamination, reduces potential exposure to silicosis in a user, reduces cost and allows flexibility during transload, and can be locked on existing intermodal rails transport, for example, about 4 numbers per car for a capacity of about 100 tons per rail car. The compartments 105 of the material storage and transfer system 100 disclosed herein further reduces employee exposure to fine particulates generated during existing transloading process, reduces product degradation and shrinkage by eliminating handling of product, eliminates the need for silos and infrastructure at the transload location, convenient storage eliminates rail demurrage, multiple products staged close to well location for inventory flexibility and reduction of trucking costs. The material storage and transfer system 100 can unload, for example, about 25 tons of sand in about 45 minutes using pumped air from the air blower 108.

The material storage and transfer system 100 disclosed herein further comprises a Global positioning system (GPS) software tracking system that provides real time information to the users on their inventory. A mobile application is also provided to a user to communicate with the material storage and transfer system 100 via a network. Each material storage and transfer system 100 or locker is located via GPS, for example, about two times per day and can be tracked globally. The inventory locations can be “geo fenced” to determine the inventory “on demand” at different sites. The features of the mobile application comprises, in an example, 4 quadrants show where the materials or products are located and in what stage of the inventory. The 4 quadrants are, for example, “empty and available”, “loaded and at location”, “loaded and en-route”, and “empty and returning”. The inventory is tracked based on destination, product contents, etc. Individual lockers can be viewed using the mobile application. Multiple data are attached to the lockers comprising, for example, sieve analysis, test data, material safety data sheet (MSDS), bills of landing. The inventory can be further viewed via an interactive map on the mobile application. The locker can be tracked into and out of available inventory using quality control (QC) labels and application readers.

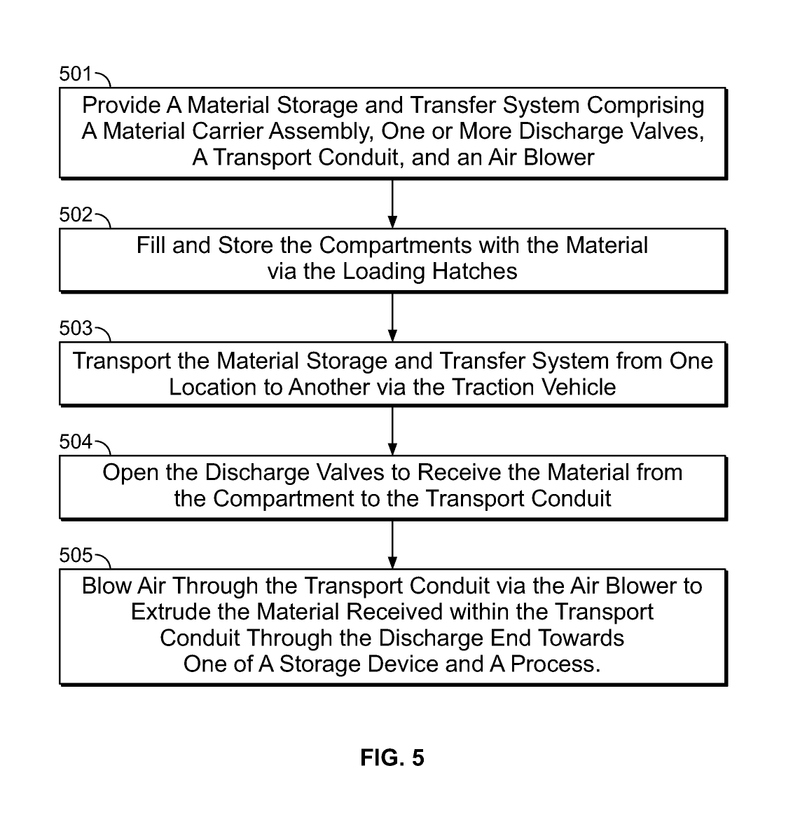

FIG. 5 exemplarily illustrates a method of storing, transporting and transferring a material using the material storage and transfer system 100. The material storage and transfer system 100 disclosed herein comprising a material carrier assembly 101, one or more discharge valves 106, a transport conduit 107, and an air blower 108 is provided 501. The material carrier assembly 101 comprises a framework 102 and one or more compartments 105. The compartments 105 are filled and stored 502 with the material via the loading hatches 110. The traction vehicle transports 503 the material storage and transfer system 100 from one location to another. The discharge valves 106 are opened 504 to receive the material from the compartment 105 to the transport conduit 107. The air blower 108 blows 505 air through the transport conduit 107 to extrude the material received within the transport conduit 107 through the discharge end 109 towards an external storage device or an external process.

The foregoing examples have been provided merely for the purpose of explanation and are in no way to be construed as limiting of the present concept disclosed herein. While the concept has been described with reference to various embodiments, it is understood that the words, which have been used herein, are words of description and illustration, rather than words of limitation. Further, although the concept has been described herein with reference to particular means, materials, and embodiments, the concept is not intended to be limited to the particulars disclosed herein; rather, the concept extends to all functionally equivalent structures, methods and uses, such as are within the scope of the appended claims. Those skilled in the art, having the benefit of the teachings of this specification, may affect numerous modifications thereto and changes may be made without departing from the scope and spirit of the concept in its aspects.

1. An ISO material storage and transfer system configures to be transported on a traction vehicle, comprising:
a) a material carrier assembly comprising:
i) a framework comprising locking apertures to removably attach to an ISO trailer platform of the traction vehicle and to removably attach to another material carrier assembly; and
ii one or more compartments positioned within the framework, the compartments configures to store a material for transport;
b) one or more discharge valves fixedly attached to a bottom section of each of the compartments; and
c) a transport conduit in communication with the discharge valves configured to receive the material, wherein one end of the transport conduit is connected to an air blower and an opposing end is defined as a discharge end;
wherein the air blower configured to blow air through the transport conduit to extrude the material received within the transport conduit through the discharge end towards one of an external storage device and an external process; and
wherein the discharge valves comprise a set of pneumatic valves and a set of gravity valves configured to be selectively activated during material transport discharge.

2. The material and storage and transfer system of claim 1, wherein the transport conduit is an air transport pipe.

3. The material and storage and transfer system of claim 1, further comprises one or more loading hatches position on an upper surface of the compartments, wherein the loading hatches are configured to fill the compartments with the material.

4. The material and storage and transfer system of claim 1, wherein the compartments are isolated from each other via internal dividers, wherein each isolated compartment is configured to be loaded with a different material.

5. (canceled)

6. (canceled)

7. The material storage and transfer system of claim 1, further comprises an air pressurization pipe fixedly attached to the upper surface of the compartments, wherein the air pressurization pipe is configured to supply pressurized air from the air blower to pressurize the materials in the compartments therefore to increase the rate of extrusion via the discharge valves.

8. (canceled)

9. A method of storing, transporting and transferring a material comprising the steps of:
a) providing a material storage and transfer system comprising:
i) a material carrier assembly comprising:
1) a framework comprising locking apertures to removably attach to a trailer platform of the traction vehicle and to removably attach to another material carrier assembly;
2) one or more compartments within the framework, the compartments configured to store a material for transport;
3) one or more loading hatches positioned on an upper surface of the compartment; and
4) one or more discharge valves fixedly attached to a bottom section of each of the compartments;
ii) a transport conduit in communication with the discharge valves configured to receive the material, wherein one end of the transport conduit is connected to an air blower and an opposing end is defined as a discharge end;
b) filling and storing the compartments with the material via the loading hatches;
c) transporting the material storage and transfer system from one location to another via the traction vehicle;
d) opening the discharge valves to receive the material from the compartment to the transport conduit; and
e) blowing air through the transport conduit via the air blower to extrude the material received within the transport conduit through the discharge end towards one of an external storage device and an external process;
wherein the discharge valves comprise a set of pneumatic valves and a set of gravity valves configured to be selectively activated during material transport discharge.
